(19) United States
(12) Patent Application Publication
(10) Pub. No.: US 2025/0124141 A1
(43) Pub. Date: Apr. 17, 2025

(54) INFORMATION PROCESSING DEVICE, METHOD FOR CONTROLLING INFORMATION PROCESSING DEVICE, AND NON-TRANSITORY COMPUTER READABLE MEDIUM

(71) Applicant: NEC Corporation, Tokyo (JP)

(72) Inventor: Jun FURUKAWA, Tokyo (JP)

(73) Assignee: NEC Corporation, Tokyo (JP)

(21) Appl. No.: 18/888,267

(22) Filed: Sep. 18, 2024

(30) Foreign Application Priority Data
Oct. 17, 2023 (JP) 2023-178851

(51) Int. Cl. G06F 21/60; G06F 12/0868

(52) U.S. Cl. CPC G06F 21/602; G06F 12/0868

(57) ABSTRACT

An information processing device includes an authenticated memory encryption engine configured to perform a cryptographic process and an authentication process using an authentication tree for data to be exchanged between a data cache and a memory, and perform an authentication process for at least one tag respectively generated in at least one node present on a path from a leaf node to which the data is assigned to a root node, in which a counter assigned to each node in the authentication tree is formed of a major counter and a minor counter, the major counter is shared by a plurality of nodes having a common parent node, and the authenticated memory encryption engine is further configured to be able to wait for a process for updating a value of the major counter which occurs as a result of a process for updating a value of the minor counter.

### INCORPORATION BY REFERENCE

This application is based upon and claims the benefit of priority from Japanese patent application No. 2023-178851, filed on Oct. 17, 2023, the disclosure of which is incorporated herein in its entirety by reference.

### TECHNICAL FIELD

The present disclosure relates to an information processing device, a method for controlling an information processing device, and a non-transitory computer readable medium storing a control program.

### BACKGROUND ART

A storage area of an information processing device installed in a computer or the like is divided into a plurality of layers such as a register, a cache, a memory, and a storage. It should be noted that before data is exchanged between a cache and a memory, the data is authenticated and encrypted and/or decrypted. By doing so, it is possible to prevent data stored in such an information processing device from being leaked due to a physical attack on the information processing device from the outside. Hereinafter, authentication of data and a cryptographic processing of data which are performed when the data is exchanged between a cache and a memory are also collectively referred to as an authenticated cryptographic process.

Further, in recent years, developments in regard to authentication of data using an authentication tree consisting of a plurality of nodes connected with one another in a tree shape in which a pair of a counter and an identifier is assigned to each of the nodes have been pursued. In the authentication process using the authentication tree, not only a verification for data assigned to a leaf node, which is a node in the lowest layer, among a plurality of nodes constituting the authentication tree is performed, but also verifications for authenticators (tags) respectively assigned to all nodes present on a path from this leaf node to the root node are performed. Therefore, the risk of leakage of data is further reduced, and the confidentiality is improved. A technology related to the authentication of data using an authentication tree is disclosed, for example, in Patent Literature 1.
Patent Literature 1: Published Japanese Translation of PCT International Publication for Patent Application, No. 2020-529657

In the authentication process using an authentication tree, an address space covered by the authentication tree is what should be authenticated. In other words, a plurality of address spaces respectively assigned to a plurality of leaf nodes, which are nodes in the lowest layer of the authentication tree, among a plurality of nodes constituting the authentication tree, are what should be authenticated. Therefore, one leaf node and another leaf node may hang from a common ancestor node. Therefore, when access to data assigned to the one leaf node and access to data assigned to the other leaf node are performed in parallel with each other, processes for updating the common ancestor node by these accesses may conflict with each other.

To avoid such a situation, in an authentication process using an authentication tree, when access (first access) to data assigned to one leaf node (first node) and subsequent access (second access) to data assigned to another leaf node (second node) are performed, they are performed as follows.

Firstly, as the first access starts, among the nodes present on a path from the first node to the root node, all nodes present on a path from the first node to a node at which a cache line is cached and which is closest to the first node are locked (i.e., are secured so that they are not accessed from any other nodes), and then the locked nodes are updated. Further, as the second access starts, among the nodes present on a path from the second node to the root node, all nodes present on a path from the second node to a node at which a cache line is cached and which is closest to the first node are locked, and then the locked nodes are updated. Note that when a third node (i.e., a common ancestor node) which is a node already locked for the first access is present among the nodes present on the path from the second node to the root node, all nodes present on a path from the second node to a node immediately before the third node are locked. Then, after all nodes locked for the first access are unlocked (i.e., released from the secured state), among the nodes present on a path from the third node to the root node, the remaining nodes present on the path from the third node to a node at which a cache line is cached and which is closest to the first node are locked, and then the locked nodes are updated.

However, in such an authentication process, for example, in the case where the counter is a split counter, if it becomes necessary to perform a process for updating a node locked for the second access in conjunction with (or as a result of) a process for updating another node locked for the first access, it is impossible to perform a process for updating this node locked for the second access. That is, in the related technology, there is a problem that it is impossible to correctly perform parallel processing of authentication processes using an authentication tree.

### SUMMARY

An object of the present disclosure is to provide an information processing device, a method for controlling an information processing device, and a control program capable of solving the above-described problem.

An information processing device according to an aspect of the present disclosure includes: a memory; an authentication tree cache in which some of counters, identifiers, and tags generated by using the counters and the identifiers, are temporarily stored, the counters and the identifiers being included in the authentication tree including a plurality of nodes connected with one another in a tree shape in which a pair of a counter and an identifier is assigned to each of the nodes; a data cache in which some of a plurality of data respectively assigned to a plurality of leaf nodes are temporarily stored, the plurality of leaf nodes being nodes located in a lowest layer of the authentication tree among the plurality of nodes constituting the authentication tree; and an authenticated memory encryption engine configured to perform a cryptographic process and an authentication process using the authentication tree for data to be exchanged between the data cache and the memory, and perform an authentication process for at least one tag respectively generated at at least one node present on a path from a leaf node to which the data is assigned to a root node, in which each of counters assigned to respective nodes in the authentication tree is formed of a major counter of which a value is represented by, among a plurality of bits representing the value of the counter, a high-order bit, and a minor counter of which a value is represented by a low-order bit thereof, and the major counter is shared by a plurality of nodes having a common parent node, and the authenticated memory encryption engine is configured, for the major counter and the minor counter assigned to each node, to be able to wait for a process for updating a value of the major counter which occurs as a result of a process for updating a value of the minor counter.

A method for controlling an information processing device according to an aspect of the present disclosure is a method for controlling an information processing device, the information processing device including: a memory; an authentication tree cache in which some of counters, identifiers, and tags generated by using the counters and the identifiers, are temporarily stored, the counters and the identifiers being included in the authentication tree including a plurality of nodes connected with one another in a tree shape in which a pair of a counter and an identifier is assigned to each of the nodes; a data cache in which some of a plurality of data respectively assigned to a plurality of leaf nodes are temporarily stored, the plurality of leaf nodes being nodes located in a lowest layer of the authentication tree among the plurality of nodes constituting the authentication tree; and an authenticated memory encryption engine configured to perform a cryptographic process and an authentication process using the authentication tree for data to be exchanged between the data cache and the memory, and perform an authentication process for at least one tag respectively generated at at least one node present on a path from a leaf node to which the data is assigned to a root node, in which each of counters assigned to respective nodes in the authentication tree is formed of a major counter of which a value is represented by, among a plurality of bits representing the value of the counter, a high-order bit, and a minor counter of which a value is represented by a low-order bit thereof, and the major counter is shared by a plurality of nodes having a common parent node, the method including: delaying, for the major counter and the minor counter assigned to each node, a process for updating a value of the major counter which occurs as a result of a process for updating a value of the minor counter, performing a process for updating a value of another minor counter assigned to another node of which a parent node is the same as that of the node to which the minor counter is assigned, and performing a process for updating the value of the major counter.

A control program according to an aspect of the present disclosure is a control program for causing a computer to perform a process for controlling an information processing device, the information processing device including: a memory; an authentication tree cache in which some of counters, identifiers, and tags generated by using the counters and the identifiers, are temporarily stored, the counters and the identifiers being included in the authentication tree including a plurality of nodes connected with one another in a tree shape in which a pair of a counter and an identifier is assigned to each of the nodes; a data cache in which some of a plurality of data respectively assigned to a plurality of leaf nodes are temporarily stored, the plurality of leaf nodes being nodes located in a lowest layer of the authentication tree among the plurality of nodes constituting the authentication tree; and an authenticated memory encryption engine configured to perform a cryptographic process and an authentication process using the authentication tree for data to be exchanged between the data cache and the memory, and perform an authentication process for at least one tag respectively generated at at least one node present on a path from a leaf node to which the data is assigned to a root node, in which each of counters assigned to respective nodes in the authentication tree is formed of a major counter of which a value is represented by, among a plurality of bits representing the value of the counter, a high-order bit, and a minor counter of which a value is represented by a low-order bit thereof, and the major counter is shared by a plurality of nodes having a common parent node, the program being configured to further cause the computer to perform: a process for delaying, for the major counter and the minor counter assigned to each node, a process for updating a value of the major counter which occurs as a result of a process for updating a value of the minor counter, a process for performing a process for updating a value of another minor counter assigned to another node of which a parent node is the same as that of the node to which the minor counter is assigned, and a process for performing a process for updating the value of the major counter.

### BRIEF DESCRIPTION OF DRAWINGS

The above and other aspects, features and advantages of the present disclosure will become more apparent from the following description of certain exemplary example embodiments when taken in conjunction with the accompanying drawings, in which:

FIG. 1 is a block diagram showing an example of a configuration of an information processing device according to the present disclosure;

FIG. 2 is a conceptual diagram of an authentication tree;

FIG. 3 shows relationships between nodes constituting the authentication tree and cache lines corresponding thereto;

FIG. 4 is a diagram for explaining parallel processing of authentication processes using an authentication tree;

FIG. 5 is a diagram for explaining an example of a flow for deleting and adding nodes in the authentication tree;

FIG. 6 is a flowchart showing a flow of a process for adding a node in the authentication tree;

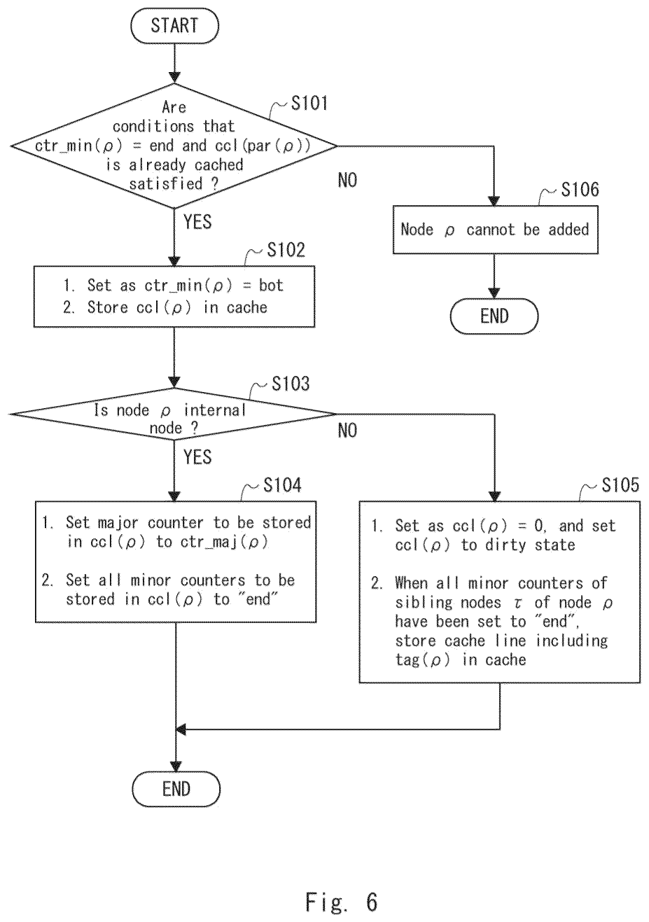

FIG. 7 is a flowchart showing a flow of a process for adding a node in the authentication tree;

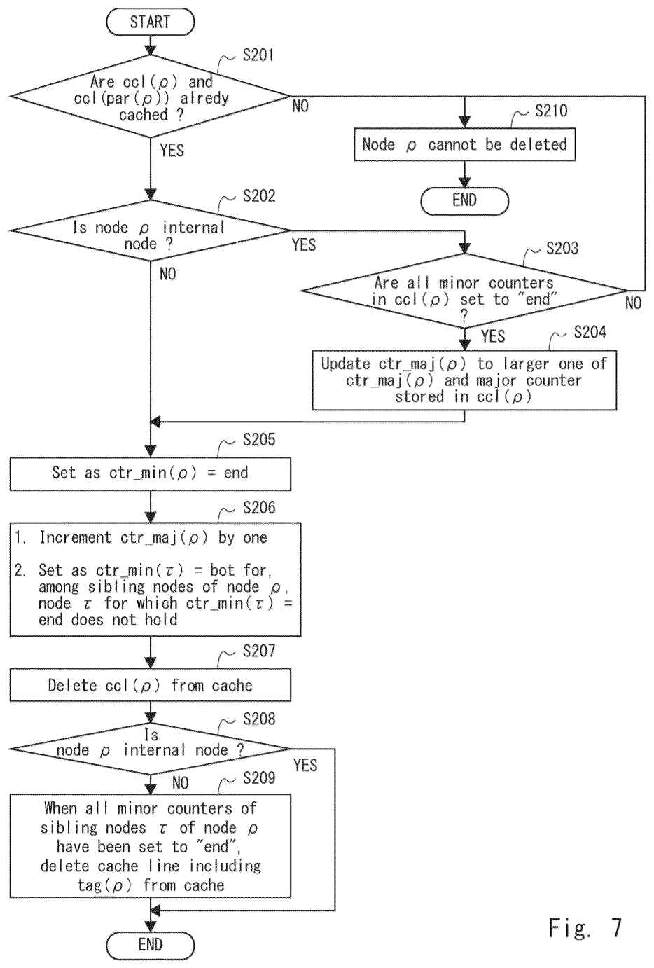

FIG. 8 is a flowchart showing a flow of a part of parallel processing of authentication processes; and

FIG. 9 is a flowchart showing a flow of a part of parallel processing of authentication processes.

### EXAMPLE EMBODIMENT

### First Example Embodiment

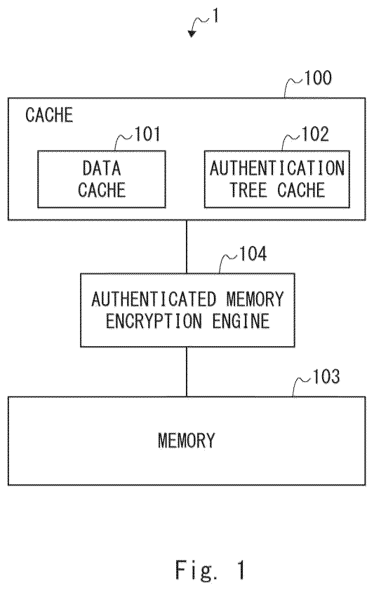

FIG. 1 is a block diagram showing an example of a configuration of an information processing device 1 according to the present disclosure. As shown in FIG. 1, the information processing device 1 includes a cache 100, a memory 103, and an authenticated memory encryption engine (AMEE; Authenticated Memory Encryption Engine) 104. The cache 100 is composed of a data cache 101 and an authentication tree cache 102. Hereinafter, the authenticated memory encryption engine 104 will be referred to as an AMEE 104.

The AMEE 104 performs, for data to be exchanged between the cache 100 and the memory 103, a cryptographic process (encryption and/or decryption) and an authentication process using an authentication tree consisting of a plurality of nodes connected with one another in a tree shape in which a pair of a counter and an identifier is assigned to each of the nodes. Note that in the authentication process using the authentication tree, not only a verification for data assigned to a leaf node, which is a node in the lowest layer, among a plurality of nodes constituting the authentication tree is performed, but also verifications for authenticators (tags) respectively assigned to all nodes present on a path from this leaf node to the root node are performed. As a result, the risk of leakage of data is reduced, and the confidentiality is improved. Note that a tag assigned to each node is generated by using a counter and an identifier assigned to that node.

In the data cache 101, data written to the memory 103 from the outside and data read from the memory 103 to the outside are temporarily stored. In the authentication tree cache 102, some of counters and identifiers assigned to respective nodes in the authentication tree, and some of tags generated by using these counters and identifiers, are temporarily stored.

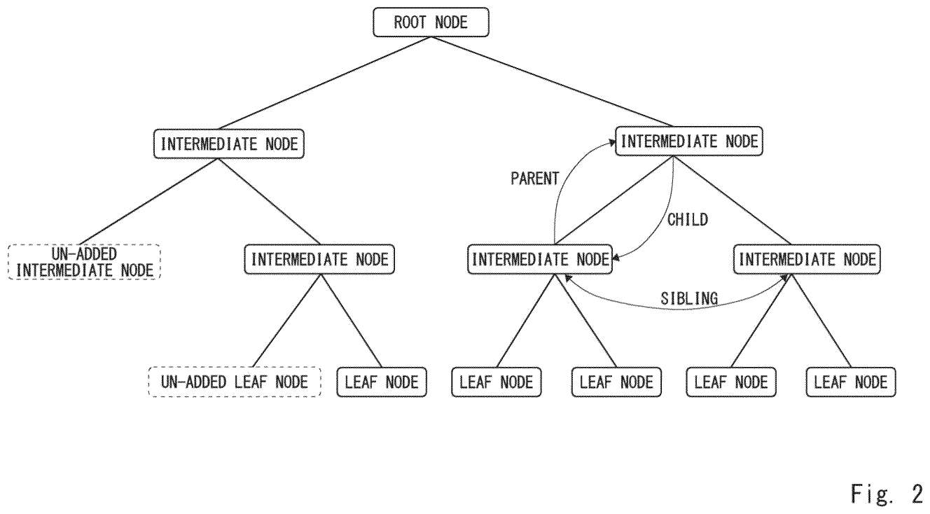

FIG. 2 is a conceptual diagram of an authentication tree. An address space covered by this authentication tree is what should be authenticated. In other words, a plurality of address spaces respectively assigned to a plurality of leaf nodes, which are nodes in the lowest layer, among a plurality of nodes constituting the authentication tree, are what should be authenticated.

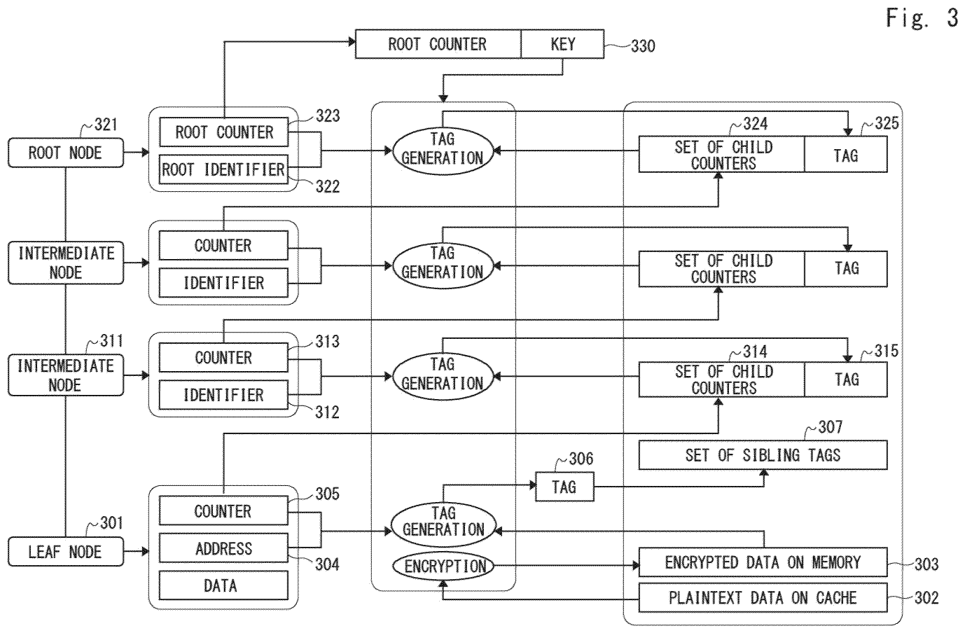

FIG. 3 shows relationships between nodes constituting the authentication tree and cache lines corresponding thereto.

A data block is assigned to each node. A unit data block assigned to each node is called a cache line. Note that it is assumed that each cache line is provided with at least a bit that indicates either “dirty” or “clean”. Note that “clean” indicates that a cache line stored in the cache 100 is the same as a corresponding cache line stored in the memory 103. Further, “dirty” indicates that a cache line stored in the cache 100 has been updated and is different from a corresponding cache line stored in the memory 103.

Further, a counter and an identifier are assigned to each node. The identifier of each leaf node (node in the lowest layer) is an address of a cache line corresponding thereto. The identifier of each intermediate node can be derived from its position in the authentication tree. For example, an identifier assigned to the parent node of a leaf node specified by a given address can be derived from the address of this leaf node.

Further, data corresponding to the address (identifier) is assigned to each leaf node. When this data is written to the data cache 101, it coincides with a cache line that is written to the data cache 101. The cache line that is written to the data cache 101 contains only data.

At a given leaf node 301, encrypted data (hereinafter, also referred to simply as ciphertext) 303 is generated by plaintext data 302 of a cache line corresponding thereto and a key 330, and a tag (authenticator, MAC) 306 is generated by the ciphertext 303, the address 304 of the leaf node 301, the value of a counter 305 of the leaf node 301, and the key 330. Note that the tag 306 generated at the leaf node 301 is stored in a cache line 307 different from the cache line of the plaintext data 302, together with a tag generated at another node (sibling node) of which the parent node is the same as that of the leaf node 301.

When the cache line assigned to the leaf node 301 is written from the data cache 101 to the memory 103, instead of the plaintext data 302, the ciphertext 303 generated by encrypting the plaintext data 302 is written to the memory 103.

In contrast, when the cache line assigned to the leaf node 301 is read from the memory 103 into the data cache 101, firstly, a tag is generated by the address 304 of the leaf node 301, the value of the counter 305 of the leaf node 301, the ciphertext 303 read from the memory 103, and the key 330. Then, only when the generated tag matches the tag 306 stored in the cache line 307, the ciphertext 303 read from the memory 103 is decrypted into plaintext data 302 by the key 330, and then the decrypted plaintext data 302 is read into the data cache 101 as the cache line of the leaf node 301. Note that in this process, the value of the counter 305 of the leaf node 301 needs to be included in the cache line of its parent node (intermediate node 311) and needs to be present in the authentication tree cache 102.

At a given intermediate node 311, a tag 315 is generated by values of the respective counters 314 of all the child nodes of the intermediate node 311, the value of the counter 313 of the intermediate node 311, the identifier 312 of the intermediate node 311, and the key 330. The cache line assigned to the intermediate node 311 is composed of values of the respective counters 314 of all the child nodes of the intermediate node 311 and the tags 315 generated at the intermediate node 311.

When the cache line assigned to the intermediate node 311 is written from the authentication tree cache 102 to the memory 103, the tag included in this cache line needs to be one that has been generated by using the values of the respective counters of all the child nodes included in the cache line. In other words, after the tag included in the cache line is generated, the value of the counter of any of the child nodes included in the cache line must not be updated.

In contrast, when the cache line assigned to the intermediate node 311 is read from the memory 103 into the authentication tree cache 102, a tag is generated by the values of the respective counters 314 of all the child nodes of the intermediate node 311 included in the cache line read from the memory 103, the value of the counter 313 of the intermediate node 311, the identifier 312 of the intermediate node 311, and the keys 330. Then, only when the generated tag matches the tag included in the cache line assigned to the intermediate node 311, the cache line read from the memory 103 is read into the authentication tree cache 102. Note that in this process, the value of the counter 313 of the intermediate node 311 needs to be included in the cache line of its parent node and needs to be present in the authentication tree cache 102.

At the root node (node in the highest layer) 321, a tag 325 is generated by the values of the respective counters 324 of all the child nodes of the root node 321, the value of the counter (root counter) 323 of the root node 321, the identifier 322 of the root node 321, and the key 330. The cache line assigned to the root node 321 is composed of the values of the respective counters 324 of all the child nodes of the root node 321 and the tags 325 generated at the root node 321.

The value of a counter assigned to a given node is updated in the following cases. When a cache line assigned to a given node is written from the cache 100 to the memory 103, and this cache line has been updated after the cache line was read from the memory 103 into the cache 100, the tag included in the cache line assigned to this node is updated after the value of the counter assigned to the node is updated. After that, the updated cache line is written from the cache 100 into the memory 103.

When data (cache line) assigned to a given leaf node is updated, in principle, the values of the respective counters of all the nodes present on the path from this leaf node to the root node are counted up. Note that the counter assigned to the root node is specially protected so as not to be directly manipulated by an attacker. Further, the tag of the corresponding node is updated by the counter of the root node, the counter of each intermediate node, or the counter and data of each leaf node. In this way, the tag of each node follows the latest status.

Note that the counter assigned to each node in the authentication tree may be formed of a major counter of which the value is represented by, among a plurality of bits representing the value of the counter, a high-order bit(s), and a minor counter of which the value is represented by a low-order bit(s) thereof. In this case, the major counter assigned to a given node is shared (i.e., is also used) by other nodes of which the parent nodes are the same as that of the given node (i.e., by sibling nodes). In this way, an increase in the scale of the counter is prevented or reduced. Further, in the cache line of a give intermediate node, as the value of the counter, the values of a plurality of minor counters respectively assigned to all the child nodes of this intermediate node and the value of one major counter shared (i.e., commonly used) by all the child nodes of the intermediate node are stored. Hereinafter, a counter formed of a major counter and a minor counter is also referred to as a split counter.

When the counter assigned to each node is a split counter, the value of the major counter is updated after the value of the minor counter is updated or the value of the minor counter is initialized. When the major counter has been updated, the values of the minor counters respectively assigned to all the nodes which share (i.e., commonly use) the major counter are initialized.

Regarding authentication processes using an authentication tree, it has been desired to improve the processing performance by performing data accesses in parallel with each other. However, when access to data assigned to one leaf node and access to data assigned to another leaf node of which the ancestor node is the same as that of the one leaf node are performed in parallel with each other, there is a possibility that processes for updating this common ancestor node that occur as a result of these accesses may conflict with each other.

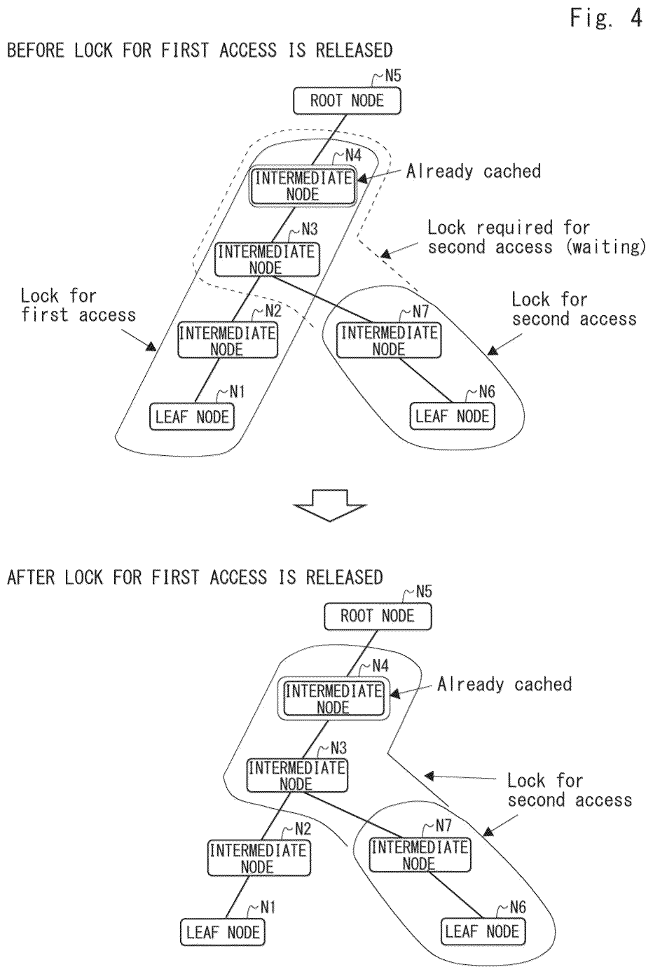

To avoid such a situation, in authentication processes using an authentication tree, when access (first access) to data assigned to one leaf node (first node) and subsequent access (second access) to data assigned to another leaf node (second node) are performed, they are performed as described below. Parallel processing of authentication processes using an authentication tree will be described hereinafter with reference to FIG. 4. FIG. 4 is a diagram for explaining parallel processing of authentication processes using an authentication tree.

Firstly, as the first access starts, the AMEE 104 locks, among the nodes present on a path from a leaf node N1 to a root node N5, all nodes N1 to N4 present on a path from the leaf node N1 to the node N4, i.e., a node at which a cache line is cached and which is closest to the leaf node N1 (e.g., among nodes at each of which a cache line is cached, one which is closest to the leaf node N1 on the path from the leaf node N1 to the root node N5) (i.e., the AMEE 104 secures all nodes N1 to N4 so that they are not accessed from any other nodes). Then, the AMEE 104 updates the locked nodes N1 to N4.

Further, as the second access starts, the AMEE 104 attempts to lock, among the nodes present on a path from a leaf node N6 to the root node N5, all nodes N6, N7, N3, and N4 present on a path from the leaf node N6 to the node N4, i.e., a node at which the cache line is cached and which is closest to the leaf node N6. However, among the nodes present on the path from the leaf node N6 to the node N4, there is the node N3 (common ancestor node) which has already been locked for the first access. In this case, the AMEE 104 first locks all the nodes N6 and N7 present on the path from the leaf node N6 to the node N7 immediately before the node N3, and after the nodes N1 to N4 locked for the first access are unlocked (i.e., released from the secured state), locks the remaining nodes N3 and N4 present on the path from the node N3 to the node N4, and then updates the locked nodes N6, N7, N3 and N4.

Note that for example, if the value of the major counter of the node N2 is updated as a result of the update of the value of the minor counter of the node N2, it is necessary to initialize not only the value of the minor counter of the node N2 but also the value of the minor counter of the node N7, which shares the major counter with the node N2 (i.e., which also uses the major counter used by the node N2). However, since the node N7 has already been locked for the second access, the minor counter of the node N7 cannot be updated.

Therefore, in the information processing device 1, the AMEE 104 is configured, for the major counter and the minor counter assigned to each node, to be able to wait for a process for updating the value of the major counter which occurs as a result of a process for updating a value of the minor counter.

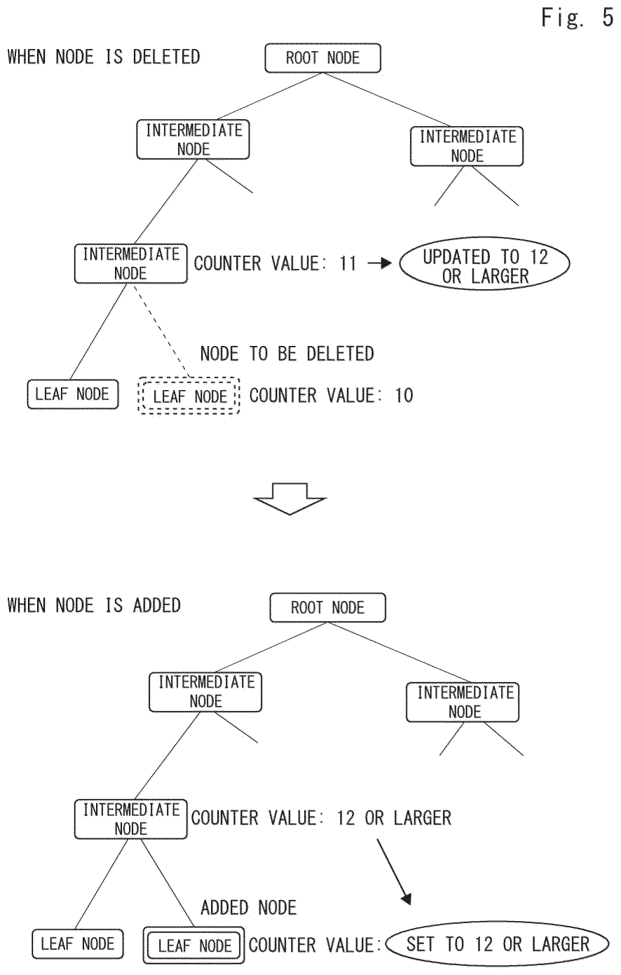

In the example shown in FIG. 5, even when the value of the major counter of the node N2 needs to be updated as a result of the process for updating the value of the minor counter of the node N2 (i.e., even when the value of the minor counter of the node N2 has been updated and the domain has been thereby used up), the AMEE 104 does not perform the process for updating the value of the major counter of the node N2, i.e., delays the process for updating the value of the major counter of the node N2. For example, the AMEE 104 first performs the process for updating the value of the minor counter assigned to the node N7 through the process for updating the node N7 for the second access, and then performs the process for updating the value of the major counter shared (i.e., commonly used) by the nodes N2 and N7. In this way, the information processing device 1 can correctly perform parallel processing of authentication processes using the authentication tree.

As described above, in the information processing device 1, the AMEE 104 is configured, for the major counter and the minor counter assigned to each node, to be able to wait for a process for updating the value of the major counter which occurs as a result of a process for updating the value of the minor counter. As a result, the information processing device 1 can correctly perform parallel processing of authentication processes using the authentication tree. That is, the information processing device 1 can improve confidentiality while improving processing performance by parallel processing.

Note that the AMEE 104 may be configured so as to update the value of a major counter shared by a plurality of nodes having the common parent node well in advance before any of minor counters respectively assigned to the plurality of nodes having the common parent node uses up the domain so that a process for updating the value of a minor counter that involves a process for updating the value of a major counter is unlikely to occur.

Further, the AMEE 104 is preferably configured so as not to accept any additional process for, among the nodes locked due to the second access following the first access, a child node of the common ancestor node, which is to be updated by the first and second accesses, before a process for updating the major counter of this child node. In the example shown in FIG. 5, the AMEE 104 is preferably configured so as not to accept any additional process for, among the nodes N6 and N7 locked due to the second access, the node N7, i.e., a child node of the common ancestor node N3, which is to be updated by the first and second accesses, before a process for updating the major counter of the node N7. In this way, it is possible to prevent the minor counter of the node N7 from being successively updated, thereby preventing the domain from being used up, before the process for updating the major counter shared by the nodes N2 and N7.

Further, the scale of the authentication tree is preferably optimized by deleting an unnecessary node(s) among the plurality of nodes constituting the authentication tree, and/or adding a node(s) that has become necessary in the authentication tree. In this way, for example, a tag(s) (authenticator(s)) related to an unused address space is deleted, so that the oppression on the storage area of the memory, which is caused by the authentication tree, is reduced. In particular, when the addresses of the memory are virtual ones, the address space to be authenticated becomes extremely larger than the actual memory size in some cases, so the optimization of the scale of the authentication tree is effective.

Therefore, when the AMEE 104 deletes any of the plurality of nodes constituting the authentication tree, it updates the value of the counter assigned to the parent node of the node to be deleted based on the value of the counter assigned to the node to be deleted. Further, when the AMEE 104 adds, to the plurality of nodes constituting the authentication tree, a new node at the position where the deleted node was originally located, it sets the value of the counter assigned to the added node based on the value of the counter assigned to the parent node of the added node.

For example, when the AMEE 104 deletes any of the plurality of nodes constituting the authentication tree, it updates the value of the counter assigned to the parent node of the node to be deleted to a value larger than a larger one of the value of the counter assigned to the parent node of the node to be deleted and the value of the counter assigned to the node to be deleted. Then, when the AMEE 104 adds a new node at the position where the deleted node was originally located in the authentication tree, it sets the value of the counter assigned to the added node to a value equal to or larger than the value of the counter assigned to the parent node of the added node.

FIG. 5 is a diagram for explaining an example of a flow for deleting and adding nodes in the authentication tree. For example, when the value of the counter assigned to the node to be deleted indicates “10” and the value of the counter assigned to the parent node of the node to be deleted indicates “11”, the AMEE 104 updates the value of the counter “11” assigned to the parent node of the node to be deleted to, for example, “12” or larger. After that, when the AMEE 104 adds a new node at the position where the deleted node was originally located in the authentication tree, it sets the value of the counter assigned to the added node to the value of the counter of its parent node or larger, i.e., sets to “12” or larger. As a result, the counter value of the node to be deleted indicates “10”, and the counter value of the added node indicates “12” or larger. That is, the counter of the node to be deleted and the counter of the added node indicate values different from each other.

As a result, the counter value of the added node always becomes larger than the counter value of the node to be deleted (i.e., the counter of the node to be deleted and the counter of the added node indicate values different from each other), so that new authentication is required when the node is added. That is, in the information processing device 1, a situation in which a node deleted in the past is added in the authentication tree again without performing any authentication thereof never occurs. As a result, the information processing device 1 can improve the confidentiality.

Note that when a counter assigned to each node in the authentication tree is a split counter, the AMEE 104 performs the following processes. For example, when the AMEE 104 deletes any of the plurality of nodes constituting the authentication tree, it updates the value of the major counter assigned to the parent node of the node to be deleted may to a value larger than a larger one of the value of the major counter assigned to the parent node of the node to be deleted and the value of the major counter assigned to the node to be deleted. Then, when the AMEE 104 adds a new node at the position where the deleted node was originally located in the authentication tree, it sets the value of the major counter assigned to the added node to a value equal to or larger than the value of the major counter assigned to the parent node of the added node. Note that when the value of the major counter shared by a plurality of nodes having the common parent node has been updated, the values of the respective minor counters of the plurality of nodes having the common parent node are initialized.

As described above, in the information processing device 1, when the AMEE 104 deletes any of the plurality of nodes constituting the authentication tree, it updates the value of the counter assigned to the parent node of the node to be deleted based on the value of the counter assigned to the node to be deleted. Further, when the AMEE 104 adds, to the plurality of nodes constituting the authentication tree, a new node at the position where the deleted node was originally located, the value of the counter assigned to the added node is set based on the value of the counter assigned to the parent node of the added node. As a result, the counter value of the node to be deleted differs from the counter value of the added node, so that new authentication is required when the node is added. That is, in the information processing device 1, a situation in which a node deleted in the past is added in the authentication tree again without performing any authentication thereof never occurs. As a result, the information processing device 1 can improve the confidentiality.

For example, a virtual machine is provided to a customer in a cloud service. A virtual memory is provided in the virtual machine. An address space larger than that of a real memory is allocated in this virtual memory. The information processing device 1 according to the present disclosure can, when it is applied to such a service, improve confidentiality while improving processing performance by parallel processing.

Further, high confidentiality is required for the management of a computer that handles financial information, computer security information, military information, health information, insurance information, or safety information. The information processing device 1 according to the present disclosure can, when it is applied to such management of a computer, improve confidentiality while improving processing performance by parallel processing.

### Second Example Embodiment

A more detailed flow of processes performed by the information processing device 1 will be described hereinafter.

In the following description, in a parallelizable authentication tree (PAT), p represents a node; ccl(ρ) represents a cache line assigned to the node ρ; par(ρ) represents a parent node of the node ρ; and Cρ represents a set of already-registered nodes among child nodes of the node ρ. The node ρ is either an internal node or a leaf node. When the node ρ is an internal node, a cache line including values of respective counters of all the child nodes of the node ρ, and a tag generated at the node ρ are assigned to the node ρ. When the node ρ is a leaf node, a cache line including memory data is assigned to the node ρ. Further, when the node ρ is a leaf node, a cache line including the tag of the node ρ and respective tags of other nodes of which the parent nodes are same as that of the node ρ are further assigned to the node ρ.

A counter ctr(ρ) is assigned to a given internal node ρ. Since a counter and an identifier are used as a nonce of a cryptographic function for generating a tag(authenticator), they need to be updated when the authentication tree is updated (including when it is updated to return to the same memory state) in order to resist a replay attack.

In the present disclosure, an example in which the counter ctr(ρ) is a split counter formed of a major counter ctr_maj(ρ) and a minor counter ctr_min(ρ) will be described. While the major counter ctr_maj(ρ) is shared (i.e., commonly used) by sibling nodes of the node ρ, the minor counter ctr_min(ρ) is uniquely assigned to the node ρ. In the cache line of the internal node ρ, a major counter ctr_maj(τ) shared by all the child nodes t of the node ρ(where τ∈Cρ), minor counters ctr_min(τ) assigned to the respective child nodes t of the node ρ, and a tag tag(ρ) generated at the node ρ are stored.

The minor counter circulates (i.e., completes a full cycle) more frequently than the major counter. Therefore, some special meanings are defined by some of the bits of the minor counter. Specifically, in the minor counter, un-registration (non-existence) of a node, the minimum value of the minor counter, and the maximum value of the minor counter are defined by some of the bits. Hereinafter, un-registration of a node is indicated by “end”; the minimum value of a minor counter is resented by “bot”; and the maximum value of a minor counter is represented by “top”.

When a node ρ is not registered, the minor counter ctr_min(ρ) of the node ρ indicates “end”. After that, when the counter ctr(ρ) of the node ρ is assigned to the authentication tree cache 102, i.e., when the node ρ is added, the minor counter ctr_min(ρ) of the node ρ is set to “bot”. After that, each time the cache line ccl(ρ) is updated, the minor counter ctr_min(ρ) is incremented by one. Further, before the minor counter ctr_min(ρ) reaches “top”, a CaryyUp(ρ) process, which is a carry-up process for the counter, is performed, so that the minor counter ctr_min(ρ) returns to “bot”. In this process, the value of the major counter ctr_maj(ρ) is incremented by one.

Note that when the node ρ does not have any child node or the like, the node ρ can be deleted (pruned). As a Prune (ρ) process, which is a process for deleting the node ρ, is performed, the minor counter ctr_min(ρ) is set to “end”. The size of the authentication tree dynamically changes as nodes are added and deleted. The root counter never leaves the authentication tree cache 102.

When the node ρ is an internal node, the tag tag(ρ) generated at the node ρ is included in the cache line ccl(ρ). However, as long as the parent node par(ρ) of the node ρ is cached, any of operations does not require ancestor nodes higher than the parent node par(ρ).

### <Hardware Configuration>

The information processing device 1 includes, as hardware, the cache 100, the memory 103, and the AMEE 104. The cache 100 is composed of a data cache 101 and an authentication tree cache 102. In the data cache 101, among data, counters, and tags, only cache lines of data are cached. Therefore, the processor can access only the data cache 101 and cannot access the authentication tree cache 102. In contrast, the AMEE 104 can access any of the data cache 101, the authentication tree cache 102, and the memory 103.

### <Definition of Processing by AMEE 104>

Firstly, a generating process Tag for generating a tag tag(ρ) assigned to an internal node ρ, performed by the AMEE 104 will be described. When sk represents a private key (key 330); ρ represents an identifier of an internal node ρ; ccl′(ρ) represents a part of a cache line ccl(ρ) of the internal node ρ other than the tag; ctr(ρ) represents a value of a counter of the internal node ρ; and tag(ρ) represents a tag generated at the internal node ρ, the generating process Tag for the tag tag(ρ) assigned to the internal node ρ, performed by the AMEE 104 is expressed as follows.
Tag (sk, ρ, ccl′(ρ), ctr(ρ))->
tag(ρ)

This indicates that the tag tag(ρ) assigned to the internal node ρ is generated by the private key sk, the identifier of the internal node ρ, the cache line ccl′(ρ), and the counter ctr(ρ).

Next, a generating process AuthEnc for generating a tag tag(ρ) assigned to a leaf node ρ and a cache line cpt(ρ) of a ciphertext, performed by the AMEE 104 will be described. When sk represents a private key; ρ represents an identifier (address) of a leaf node ρ; ccl(ρ) represents a cache line of plaintext data; ctr(ρ) represents a value of a counter of the leaf node ρ; tag(ρ) represents a tag generated at the leaf node ρ; and cpt(ρ) represents a cache line of a ciphertext, the generating process AuthEnc for generating the tag tag(ρ) assigned to the leaf node ρ and the cache line cpt(ρ) of the ciphertext, performed by the AMEE 104 is expressed as follows.
AuthEnc (sk, ρ, ccl(ρ), ctr(ρ))-> {tag(ρ), cpt(ρ)}

This indicates that the tag tag(ρ) assigned to the leaf node ρ and the cache line cpt(ρ) of the ciphertext are generated by the private key sk, the identifier of the leaf node ρ, the cache line ccl(ρ) of the plaintext data, and the counter ctr(ρ).

Next, an authenticating process VeriDec for authenticating a cache line cpt (ρ) of a ciphertext assigned to a leaf node ρ, performed by the AMEE 104 will be described. When sk represents a private key; ρ represents an identifier (address) of a leaf node ρ; cpt(ρ) represents a cache line of a ciphertext; ctr(ρ) represents a value of a counter of the leaf node ρ; tag(ρ) represents a tag assigned to at the leaf node ρ; and ccl(ρ) represents a cache line of plaintext data, the authenticating process VeriDec for authenticating the cache line cpt(ρ) of the ciphertext assigned to the leaf node ρ, performed by the AMEE 104 is expressed as follows.

$$VeriDec ( sk , ρ , cpt ( ρ ) , ctr ( ρ ) , tag ( ρ ) ) -> ccl ( ρ ) / \text{''} bot \text{''}$$

This indicates that the cache line cpt(ρ) of the ciphertext is verified by the private key sk, the identifier of the leaf node ρ, the counter ctr(ρ), and the tag tag(ρ). Further, when the authentication succeeds, the cache line ccl(ρ) of the plaintext data is generated, whereas when the authentication fails, the counter ctr (ρ) is set to “bot”.

### <Initialization of Authentication Tree>

Firstly, the initialization of the authentication tree will be described. Firstly, the AMEE 104 sets a private key sk. After that, the AMEE 104 sets the major counter ctr_maj(root) of the root node to “0” and sets the minor counter ctr_min(root) of the root node to “end”.

### <Add (ρ) Process; Process for Adding Node ρ in Authentication Tree>

Next, an Add (ρ) process performed by the AMEE 104 will be described. The Add (ρ) process is a process for adding a node ρ in the authentication tree. This process can be performed when a cache line ccl(par (ρ)) of a parent node par (ρ) of the node ρ is present in the authentication tree cache 102 and the minor counter ctr_min(ρ) of the node ρ has been set to “end” (Yes in Step S101), and is not performed in all other cases (No in Step S101) (Step S106).

When the process for adding the node ρ in the authentication tree is to be performed (Yes in Step S101), firstly, the AMEE 104 updates the minor counter ctr_min(ρ) of the node ρ from “end” to “bot”, and then stores the cache line ccl(ρ) of the node ρ in the authentication tree cache 102 (Step S102).

For example, when the node ρ is an internal node (Yes in Step S103), the AMEE 104 sets the major counter of the child node stored in the cache line ccl(ρ) of the node ρ to the same value as the value of the counter ctr_maj(ρ), and also sets the minor counters of all the child nodes stored in the cache line ccl(ρ) of the node ρ to “end” (Step S104).

On the other hand, when the node ρ is a leaf node (No in Step S103), the AMEE 104 sets the cache line ccl(ρ) of the node ρ to “0” and sets the cache line ccl(ρ) to a dirty state (Step S105). Further, when nodes t are sibling nodes of the leaf node ρ, and the minor counters ctr_min(τ) of all the sibling nodes t have been set to “end”, the AMEE 104 stores a cache line including the tag tag(ρ) of the node ρ in the authentication tree cache 102 (Step S105).

### <Prune (ρ) Process; Process for Deleting Node ρ in Authentication Tree>

Next, a Prune (ρ) process performed by the AMEE 104 will be described. The Prune (ρ) process is a process for deleting a node ρ in the authentication tree. This process can be performed when a cache line ccl(ρ) of the node ρ and a cache line ccl(par (ρ)) of a parent node par(ρ) of the node ρ are present in the authentication tree cache 102 (Yes in Step S201), and is not performed in all other cases (No in Step S201) (Step S210).

When the node ρ is an internal node (Yes in Step S201->Yes in Step S202), it is determined whether or not the minor counters of all the child nodes stored in the cache line ccl(ρ) of the node ρ have been set to “end” (Step S203).

For example, when any of the minor counters of a plurality of child nodes stored in the cache line ccl(ρ) of the node ρ has not been set to “end” (No in Step S203), the process for deleting the node ρ is not performed (Step S210).

On the other hand, when the minor counters of all the child nodes stored in the cache line ccl(ρ) of the node ρ have been set to “end” (Yes in Step S203), the AMEE 104 updates the value of the major counter ctr_maj(ρ) of the node ρ to a larger one of the value of the major counter ctr_maj(ρ) and the major counter of the child node stored in the cache line ccl(ρ) of the node ρ(Step S204).

After that, the AMEE 104 sets the minor counter ctr_min(ρ) of the node ρ to “end” (Step S205). After that, the AMEE 104 performs a Carry Up (par (ρ)) process, which is a carry-up process for a counter described later, (Step S206). Specifically, the AMEE 104 increments the value of the major counter ctr_maj(ρ) of the node ρ by one, and sets all the minor counters ctr_min(τ) of the nodes t of the sibling nodes of the node ρ which have not been set to “end” to “bot” (Step S206). After that, the AMEE 104 performs an Invalidata(ρ) process, which is a process for invalidating the node ρ described later (Step S207). Specifically, the AMEE 104 deletes the cache line ccl(ρ) of the node ρ from the authentication tree cache 102 (Step S207). Then, the series of processes are finished (Yes in Step S208).

When the node ρ is a leaf node (Yes in Step S201->No in Step S202), the AMEE 104 sets the minor counter ctr_min(ρ) of the node ρ to “end” (Step S205). After that, the AMEE 104 performs a Carry Up (par (ρ)) process (Step S206). Specifically, the AMEE 104 increments the value of the major counter ctr_maj(ρ) of the node ρ by one, and sets all the minor counters ctr_min(τ) of the nodes t of the sibling nodes of the node ρ which have not been set to “end” to “bot” (Step S206). After that, the AMEE 104 performs an Invalidata(ρ) process (Step S207). Specifically, the AMEE 104 deletes the cache line ccl(ρ) of the node ρ from the data cache 101 (Step S207).

Further, when the node ρ is a leaf node (No in Step S208), and the minor counters ctr_min(τ) of all the sibling nodes t have been set to “end”, the AMEE 104 deletes the cache line ccl(tag(ρ)) including the tag tag(ρ) of the node ρ from the authentication tree cache 102 (Step S209). Then, the series of processes are finished (Yes in Step S208).

<Read (ρ) Process; Process for Reading Cache Line from Memory into Cache>

Next, a Read (ρ) process performed by the AMEE 104 will be described. The Read (ρ) process is process for reading a cache line of a node ρ from the memory 103 into the cache 100. This process can be performed when a cache line ccl(ρ) of the node ρ is not present in either the data cache 101 or the authentication tree cache 102, and a cache line ccl(par (ρ)) of the parent node par (ρ) of the node ρ is present in the authentication tree cache 102.

When the node ρ is an internal node, firstly, the AMEE 104 reads the cache line ccl(ρ) of the node ρ from the memory 103 and performs an authentication process for this cache line ccl(ρ). Specifically, the AMEE 104 verifies whether a relation tag(ρ)=Tag (sk, ρ, ccl′(ρ), ctr(ρ)) holds or not.

When the relation tag(ρ)=Tag (sk, ρ, ccl′(ρ), ctr(ρ)) holds, the AMEE 104 stores the cache line ccl(ρ) read from the memory 103 in the authentication tree cache 102. On the other hand, when the relation tag(ρ)=Tag (sk, ρ, ccl′(ρ), ctr (ρ)) does not hold, the AMEE 104 returns information indicating that the authentication has failed to the cache 100.

When the node ρ is a leaf node, firstly, the AMEE 104 reads the cache line cpt(ρ) of the ciphertext of the node ρ from the memory 103 and reads the tag tag(ρ) to be assigned to the node ρ from the memory 103 or the authentication tree cache 102. After that, the AMEE 104 performs a decryption process and an authentication process for the cache line cpt(ρ) of the ciphertext through a VeriDec (sk, ρ, cpt(ρ), ctr(ρ), tag(ρ)) process.

When the authentication is successful, the AMEE 104 generates a cache line ccl(ρ) of plaintext data and stores the generated cache line ccl(ρ) in the data cache 101, whereas when the authentication is unsuccessful, the AMEE 104 sets the counter ctr(ρ) to “bot” and returns information indicating that the authentication has failed to the cache 100.

<WriteBack (ρ) Process; Process for Writing Back Cache Line from Cache to Memory>

Next, a WriteBack (ρ) process performed by the AMEE 104 will be described. The WriteBack (ρ) process is a process for writing back a cache line from the cache 100 to the memory 103. In the case where the node ρ is an internal node, this process can be performed when a cache line ccl(ρ) of the internal node ρ indicating a dirty state is present in the authentication tree cache 102. Further, in the case where the node ρ is a leaf node, this process can be performed when a cache line ccl(ρ) of the leaf node ρ indicating a dirty state is present in the data cache 101, and a cache line ccl(tag(ρ)) in which the tag tag(ρ) of the leaf node ρ has been stored is present in the authentication tree cache 102. However, it is necessary that the minor counter ctr_min(ρ) of the node ρ is not set to “top”.

Firstly, the AMEE 104 increments the value of the minor counter ctr_min(ρ) of the node ρ by one. After that, the AMEE 104 sets the cache line ccl(par (ρ)) of the node par(ρ) stored in the authentication tree cache 102 to a dirty state.

When the node ρ is an internal node, the AMEE 104 generates a tag tag(ρ) of the node ρ through a Tag (sk, ρ, ccl′(ρ), ctr(ρ)) process. After that, the AMEE 104 replaces the tag included in the cache line ccl(ρ) of the node ρ with a new tag, and then writes back the updated cache line ccl(ρ) to the memory 103. After that, the AMEE 104 sets the cache line ccl(ρ) of the node ρ stored in the authentication tree cache 102 to a clean state.

In the case where the node ρ is a leaf node, when the cache line ccl(tag(ρ)) is not present in the authentication tree cache 102, the AMEE 104 reads the cache line ccl(tag(ρ)) in which the tag tag(ρ) of the node ρ has been stored from the memory 103. After that, the AMEE 104 performs an encryption process for the cache line ccl(ρ) of the plaintext data through an AuthEnc (sk, ρ, ccl(ρ), ctr(ρ)) process. Specifically, the AMEE 104 encrypts the cache line ccl(ρ) of the plaintext data and thereby generates a cache line cpt(ρ) of a ciphertext and a tag tag(ρ). Then, the AMEE 104 writes back the generated cache line cpt(ρ) of the ciphertext to the memory 103. After that, the AMEE 104 sets the cache line ccl(ρ) of the plaintext data of the node ρ stored in the data cache 101 to a clean state. After that, the AMEE 104 replaces the tag of the cache line ccl(tag(ρ)) stored in the authentication tree cache 102 with a new tag.

### <Invalidate (ρ) Process; Process for Invaliding Node ρ>

Next, an Invalidate (ρ) process performed by the AMEE 104 will be described. The Invalidate (ρ) process is a process for invalidating a node ρ. This process can be performed when a cache line ccl(ρ) of the node ρ indicating a clean state is present in the data cache 101 or the authentication tree cache 102. In this case, the AMEE 104 deletes the cache line ccl(ρ) stored in the data cache 101 or the authentication tree cache 102, and thereby invalidates the cache line ccl(ρ).

<CarryUp(ρ) process; Carry-up process for Counter included in ccl(ρ)>

Next, a CarryUp(ρ) process performed by the AMEE 104 will be described. The CarryUp(ρ) process is a process for carrying up a counter (i.e., producing a carry of a counter) included in a cache line ccl(ρ) of the node ρ. This process can be performed when the cache line ccl(ρ) of the node ρ is present in the authentication tree cache 102.

Firstly, child nodes the minor counter of each of which has not been set to “end” among all the child nodes of the node ρ are referred to as child nodes ω. Then, when the child node ω is a leaf node or when no child node ω is present in the authentication tree cache 102, the AMEE 104 performs a Read (ω) process for the child node ω

After that, the AMEE 104 increments the value of the major counter (major counter assigned to the node ω) stored in the cache line ccl(ρ) of the node p by one. After that, the AMEE 104 sets the minor counter ctr_min(ω) assigned to the node ω to “bot”

After that, when the node ω is a leaf node, the AMEE 104 performs a WriteBack (ω) process for the node σ, and in all other cases, the AMEE 104 sets the cache line ccl(ω) to a dirty state.

### <Description of Parallel Processing of Authenticated Memory Encryption Processes>

Next, parallel processing of authenticated memory encryption processes will be described. Since an operation for a given node requires its parent node, this operation may recursively require many ancestor nodes. Therefore, there is a high possibility that a plurality of operations that are simultaneously performed require the same ancestor node at a specific time. Since such sharing (i.e., common use) of a node by a plurality of operations complicates parallel processing of authentication processes using an authentication tree, some ingenuity is required to perform parallel processing of authenticated memory encryption processes.

In the following description, ρ represents an arbitrary node in the authentication tree; σ represents an ancestor node of the node ρ; and path (ρ, σ) represents a set of nodes that are neither the node ρ nor the node σ and are present on a path from the node ρ to the node σ. Note that the node σ is an anchor of the node ρ, represented as anc(ρ). When the AMEE 104 reads or writes back a cache line ccl(ρ) of the node ρ from or to the memory, it is necessary to call the cache line of a node present in the path (ρ, anc(ρ)).

Firstly, several locking processes performed by the AMEE 104 will be described.

### <Cw-lock>; Counter-wise Lock>

When a node τ, which is the parent node of the node ρ, is cached in the authentication tree cache 102 or is allocated a storage area by the authentication tree cache 102, the AMEE 104 can cw-lock the node τ, which is not cw-locked for the counter ctr(ρ), for the counter ctr(ρ). The operation “cw-locking the node t for the counter ctr(ρ)” is an operation for restricting access to the node τ so that the counter ctr(ρ) does not change. Further, when the node ρ is cached in the authentication tree cache 102 or is allocated a storage area by the authentication tree cache 102, the AMEE 104 can cw-lock the node ρ, which is not cw-locked for the counter ctr(ρ), for the counter ctr(ρ). The operation “cw-locking the node ρ for the counter ctr(ρ)” is an operation for restricting access to the node ρ so that the counter ctr(ρ) does not change.

### <Ex-lock; Exclusive Lock>

When the node ρ is not allocated a storage area by the authentication tree cache 102, the AMEE 104 can ex-lock the node ρ, which has not been ex-locked yet. The operation “ex-locking the node ρ” is an operation for restricting access to the node ρ so that information assigned to the node ρ does not change. Specifically, the AMEE 104 ex-locks the node ρ by adding the address of a cache line corresponding to the node ρ in the directory, and disengages the ex-lock of the node ρ by deleting the address of the cache line corresponding to the node ρ from the directory.

Note that the AMEE 104 manages the directory in which addresses of nodes to which no storage area is allocated in the cache 100 are listed. Only the addresses of nodes to which no memory of the cache 100 is allocated are listed in the directory, and data corresponding to the nodes are not contained therein. The AMEE 104 lists up the addresses of cache lines that are not cached in the authentication tree cache 102 in the directory, and by doing so, ex-locks the nodes having these addresses.

### <Sp-lock>; Split Counter Lock>

The AMEE 104 can sp-lock a node ρ that has not been sp-locked yet for a first operation. The AMEE 104 does not accept the sp-locking of the node ρ, which has already been sp-locked, for a second operation following the first operation, and permits only the access to the node ρ for the first operation. The sp-locking of a node ρ means that the AMEE 104 restricts access to any of the child nodes of the node ρ that is made (i.e., is attempted to be made) to perform a CarryUp(ρ) process. There is a possibility that when the AMEE 104 tries to perform a CarryUp(ρ) process, a child node of the node ρ has already been locked by another operation (preceding operation). Note that canceling the preceding operation complicates the process. Therefore, the AMEE 104, while completing the preceding operation, blocks (i.e., prevents) the access to any of the child nodes of the node ρ made by an operation performed after the preceding operation by the sp-locking thereof.

The structure for the CarryUp and the sp-locking is the key to enable the delayed updating of a major counter and/or a split counter, and the parallel processing to coexist (i.e., enable all of them to be correctly implemented) (which will be described later).

Next, several basic processes necessary for parallel processing of authentication processes using an authentication tree will be described. Specifically, each of ConRead (ρ), ConWriteBack (ρ), ConCarryUp(ρ), ConAdd (ρ), ConPrune (ρ), and ConInvalidate (ρ) processes will be described. When the node ρ is a leaf node, these processes are performed when it is requested from the data cache 101, whereas when the node ρ is an internal node, they are performed when it is requested from the authentication tree cache 102.

### <ConRead (ρ) Process>

A ConRead (ρ) process performed by the AMEE 104 will be described hereinafter. The ConRead (ρ) process is a process for reading a cache line from a memory into a cache during parallel processing. This process can be performed when the node ρ is registered in the authentication tree. When the node ρ is not registered in the authentication tree, the AMEE 104 registers the node ρ in the authentication tree by performing a ConAdd (ρ) process (which will be described later).

Firstly, a process that needs to be performed as a prerequisite for the ConRead (ρ) process will be described. Assume that when the node ρ is a leaf node, the data cache 101 allocates, for a cache miss of the node ρ, a storage area of a cache line ccl(τ) of the node τ as a storage area of a cache line ccl(ρ) of the node ρ. In this case, when the cache line ccl(τ) indicates a dirty state, the data cache 101 makes the AMEE 104 perform a ConWriteBack (τ) process (which will be described later). In this way, the AMEE 104 can allocate a cache line indicating a clean state to the node ρ. After that, the data cache 101 makes the AMEE 104 perform a ConRead (ρ) process. Upon receiving the cache line ccl(ρ) from the AMEE 104, the data cache 101 rewrites the cache line ccl(τ) indicating the clean state into the cache line ccl(ρ). Note that the above-described cache miss of the node ρ is caused by the reading of the node ρ by the CPU or the prefetcher of the data cache 101.

Assume that when the node ρ is an internal node, the AMEE 104 has inquired whether or not the node ρ is cached in the authentication tree cache 102, and received, from the authentication tree cache 102, a response indicating that the node ρ has been cache-missed and hence has not been locked. In this case, it is assumed that a cache line ccl(τ) corresponding to a given node τ and indicating a clean state has not been locked, has been invalidated by an invalidate (τ) process, and has been allocated as a storage area of the cache line ccl(ρ) of the node ρ. In this case, the AMEE 104 cw-locks the node ρ for this cache line ccl(ρ). In this state, the AMEE 104 performs a ConRead (ρ) process. When there is no cache line in a clean state to which the cache line ccl(ρ) of the node ρ can be allocated in the authentication tree cache 102, unlike the typical caching operation, the cache line ccl(ρ) has not been allocated to the authentication tree cache 102. In this case, the AMEE 104 performs a ConWriteBack (τ) process (which will be described later) for the node τ, which is not locked. Note that the cache miss of the node ρ is caused by the reading of the node ρ by the AMEE 104 or the prefetcher of the authentication tree cache 102.

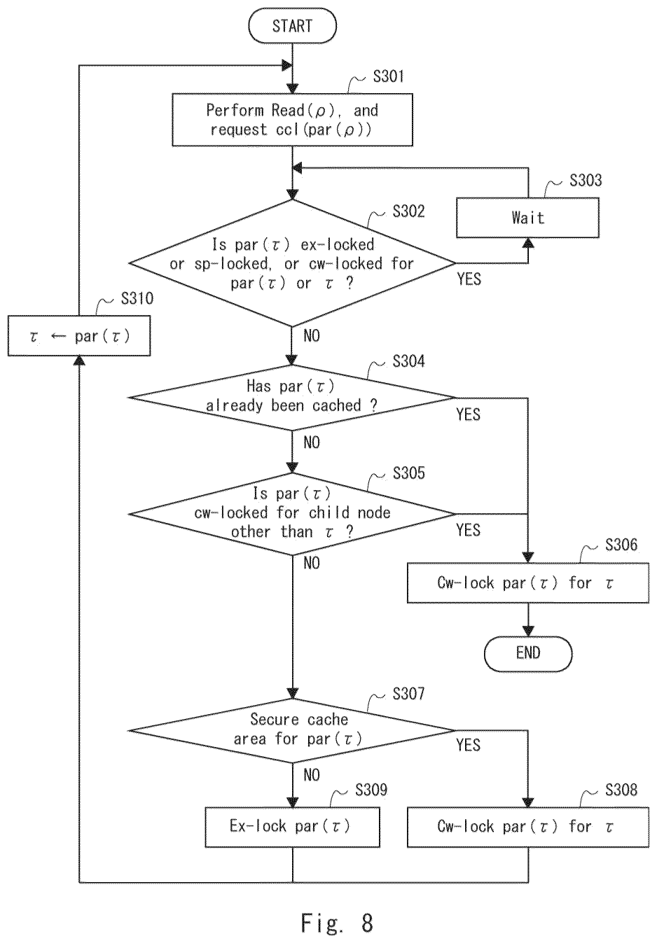

Next, a process performed in a lock phase of the ConRead (ρ) process will be described with reference to FIG. 8. Firstly, the AMEE 104 requests a cache line ccl(par (ρ)) of the parent node par(ρ) of the node ρ from the authentication tree cache 102 by performing a Read (ρ) process (Step S301). Specifically, the AMEE 104 performs the below-described process every time it requests a cache line ccl(par (τ)) of the parent node par(τ) of a given node τ from the authentication tree cache 102. That is, when the node par(τ) is ex-locked or sp-locked, or is cw-locked for the node par(τ) or the node τ (Yes in Step S302), the AMEE 104 waits until this lock is disengaged (Step S303).

When the node par(τ) is neither ex-locked nor sp-locked, and is not cw-locked for either the node par(τ) or the node τ (No in Step S302), and when the node par(τ) is cached in the authentication tree cache 102 (Yes in Step S304), the AMEE 104 cw-locks the node par(τ) for the node τ (i.e., for the counter of the node τ) and finishes the series of processes in the lock phase (Step S306).

When the node par(τ) is allocated a storage area by the authentication tree cache 102 but is not cached (No in Step S304), and when the node par(τ) is cw-locked for a child node (i.e., for the counter of a child node) which is a node other than the node τ and to which a storage area is allocated in the cache (Yes in Step S305), the AMEE 104 cw-locks the node par(τ) for the node τ (i.e., for the counter of the node τ), determines to acquire a cache line ccl(par (τ)) as an anchor at the end of the memory phase (which will be described later), and finishes the series of processes in the lock phase (Step S306).

When the node par(τ) is allocated a storage area by the authentication tree cache 102 but is not cached (No in Step S304), and when the node par(τ) is not cw-locked for a child node (i.e., for the counter of a child node) of the node par (τ) to which a storage area is allocated in the cache (No in Step S305), the AMEE 104 determines whether or not to allocate a storage area of the cache line of the node par(τ) in the authentication tree cache 102 (Step S307).

When the AMEE 104 allocates the cache line of the node par(τ) in the authentication tree cache 102 (Yes in Step S307), it cw-locks the node par(τ) for the node τ (i.e., for the counter of the node τ) (Step S308), whereas when the AMEE 104 does not allocate the cache line (No in Step S307), it ex-locks the node par(τ) (Step S309). These locks are simultaneously performed with the cache miss. After these locks, the AMEE 104 replaces the parent node par(ρ) of the node ρ with the node ρ(Step S309), and returns to the process in the step S301.

Next, a process in a memory phase of the ConRead (ρ) process will be described. Firstly, regarding the Read (τ) process for each node τ performed in the lock phase, the AMEE 104 waits without requesting a cache line of each node t from the memory 103 until the phase changes from the lock phase to the memory phase. When the AMEE 104 needs to request a cache line from the memory 103, the AMEE 104 performs processes so that all such requests are satisfied in the memory phase. The AMEE 104 waits for a memory response and eventually receives the response.

When an anchor π is stored in the authentication tree cache 102 by a preceding process, the AMEE 104 requests and receives the anchor π from the authentication tree cache 102 through a bypass channel.

Next, a process performed in an unlock phase of the ConRead (ρ) process will be described. The AMEE 104 performs the below-described process for each of all nodes τ present on a path from a child node of the anchor π (cached node) to the node ρ in order (i.e., in a descending order).

Firstly, when the Read (par (τ)) process is completed or when the node par (τ) is the anchor π, the AMEE 104 resumes the Read (τ) process.

When the Read (τ) process for the node τ, which is not the node ρ, is completed, the AMEE 104 unlocks the cache line ccl(par (τ)) of the node par(τ). When the cache line ccl(τ) is allocated in the authentication tree cache 102, the AMEE 104 moves this cache line ccl(τ) to the authentication tree cache 102, whereas when it is not allocated in the authentication tree cache 102, the AMEE discards the cache line ccl(τ).

After that, when the Read (ρ) process for the node ρ is completed, the AMEE 104 unlocks the cache line ccl(par (ρ)) of the node ρ. After that, the AMEE 104 moves the cache line ccl(ρ) to the allocated cache line storage area. When the node ρ is an internal node, the AMEE 104 unlocks this node ρ.

### <ConWriteBack (ρ) Process>

Next, a ConWriteBack (ρ) process performed by the AMEE 104 will be described. The ConWriteBack (ρ) process is a process for writing back a cache line from a cache to a memory during parallel processing.

Here, it is assumed that the cache line ccl(ρ) has been cached and indicates a dirty state. Further, it is assumed that when the node ρ is an internal node, the node ρ is not cw-locked for the node ρ. When the data cache 101 or the prefetcher of the AMEE 104 finds a cache line indicating a dirty state, it can call a ConWriteBack (ρ) process.

Next, a process performed in a lock phase of the ConWriteBack (ρ) process will be described.

When the node ρ is an internal node, the AMEE 104 cw-locks the node ρ for the node ρ. In this state, the AMEE 104 does not perform the Read (ρ) process. Further, the AMEE 104 specifies, among the nodes cached in the authentication tree cache 102 or the nodes for which storage areas are allocated in the authentication tree cache 102, a node σ, which is an ancestor node closest to the node ρ, as a new anchor.

The rest of the processes in the lock phase of the ConWriteBack (ρ) process are similar to those in the lock phase of the ConRead (ρ) process, and therefore descriptions thereof will be omitted.

Next, a process performed in a memory phase of the ConWriteBack (ρ) process will be described. The processes in the memory phase of the ConWriteBack (ρ) process are similar to those in the memory phase of the ConRead (ρ) process, and therefore descriptions thereof will be omitted.

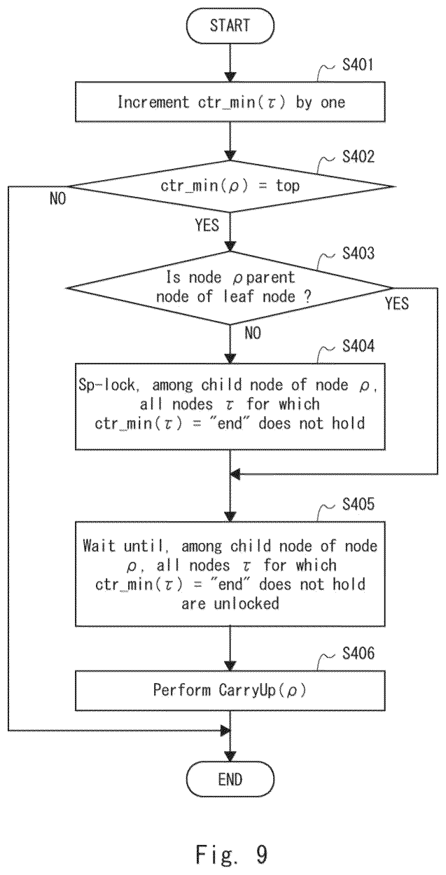

Next, a process performed in an unlock phase of the ConWriteBack (ρ) process will be described with reference to FIG. 9. Processes in the unlock phase of the ConWriteBack (ρ) process are similar to those in the unlock phase of the ConRead (ρ) process except that the nodes from the node ρ to the child node of the anchor σ are not unlocked. Note that when the ancestor node σ is not cached, the AMEE 104 stores the cache line ccl(σ) in the authentication tree cache 102.

The AMEE 104 performs the below-described process for each of all nodes present on the path from the node ρ to the child node of the ancestor node σ in order (i.e., in an ascending order).

Firstly, the AMEE 104 performs a WriteBack (τ) process. As a result, the value of the minor counter ctr_min(τ) of the node τ is incremented by one (Step S401). Note that when the node par(τ) is an anchor, the AMEE 104 limits the update of the authentication tree cache 102 to only the counter ctr(τ) of the node par (τ) (i.e., updates only the counter ctr(τ) of the node par(τ)). Note that counters other than that of the node par(τ) may have been updated in other processes. When the minor counter ctr_min(τ) of the node τ reaches “top” (Yes in Step S402), the AMEE 104 performs a ConCarryUp (par (τ)) process (which will be described later) through a bypass channel (Steps S403 to S406). Note that the AMEE 104 makes a copy of the cache line ccl(par (τ)) of the node par(τ) and passes the copy to the ConWriteBack (par (ρ)) process. When the node par(τ) is ex-locked, the AMEE 104 does not disengage the ex-lock of the node par(ρ) by the below-described process. Specifically, when the node par(τ) is cw-locked for a given node, the AMEE 104 cw-locks the node par(τ) for the node par(τ). When the node τ is an internal node, the AMEE 104 unlocks the cache line ccl(τ) of the node τ.

Then, the AMEE 104 unlocks the cache line ccl(σ) of the ancestor node σ.

Next, a ConCarryUp(ρ) process will be described with reference to FIG. 9. This process is called only from the ConWriteBack (ρ) process and a ConPrune (ρ) process (which will be described later) through a bypass channel.

Firstly, a process performed in a lock phase of the ConCarry Up(ρ) process will be described. When any of the child nodes of the node ρ is sp-locked, i.e., when a ConCarryUp(ρ) process other than the ConCarry Up(ρ) process of interest (i.e., the ConCarryUp(ρ) process described here) has already been performed, the AMEE 104 cancels the ConCarryUp(ρ) process of interest. However, the lock of each of the node ρ and the cache line ccl(ρ) is taken over (i.e., continued).

When the node ρ is not the parent node of a leaf node (No in Step S403), the AMEE 104 requests all child nodes τ of the node ρ for each of which the minor counter ctr_min(τ) is not set to “end” from the authentication tree cache 102, and sp-locks these nodes τ (Step S404). Note that the ex-lock of the node t prevents nether the progress of this process nor the sp-lock.

After that, the AMEE 104 receives a response from the authentication tree cache 102. This response includes the status of each node (specifically, a state in regard to cw-locked, ex-locked, allocated, cached, and the like of each node). The AMEE 104 also receives information about the storage area(s) of a cached node(s).

Next, a process performed in a memory phase of the ConCarryUp(ρ) process will be described.

When the node ρ is the parent node of a leaf node (Yes in Step S403), the AMEE 104 performs a Read (τ) process for all child nodes τ of the node ρ for each of which the minor counter ctr_min(τ) is not set to “end” (Step S405).

Further, when the node ρ is not the parent node of a leaf node and is ex-locked (No in Step S403), the AMEE 104 performs a Read (τ) process for each of all nodes τ that are not cached (Step S405).

Further, when the node ρ is not the parent node of a leaf node and is not ex-locked (Yes in Step S403), the AMEE 104 performs a Read (τ) process for each of all nodes τ that are neither cached and nor cw-locked (Step S405).

Then, the AMEE 104 eventually receives the cache line that it has requested from the memory 103.

When the node ρ is not the parent node of a leaf node and the status of the node τ stored in the authentication tree cache 102 has been updated in the preceding process, and when the node ρ is not ex-locked, the AMEE 104 requests and receives all nodes τ that are in similar states from the authentication tree cache 102 through a bypass channel.

Next, a process performed in an unlock phase of the ConCarryUp(ρ) process will be described.

The AMEE 104 performs the remaining processes of the Carry Up(ρ) process except for a process for setting the cached cache line in a dirty state (Step S406).

Note that when the node ρ is the parent node of a leaf node, the AMEE 104 performs a WriteBack (τ) process for each of all child nodes τ of the node ρ for each of which the minor counter is not set to “end”.

On the other hand, when the node ρ is not the parent node of a leaf node, the AMEE 104 performs a WriteBack (τ) process when the following conditions are satisfied. Specifically, firstly, when the node ρ is ex-locked and when a node t which is included in the child nodes of the node ρ and for which the minor counter is not set to “end” is not cached, the AMEE 104 performs a WriteBack (τ) process. Further, when the node ρ is not ex-locked and when a node τ which is included in the child nodes of the node ρ and for which the minor counter is not set to “end” is neither cached nor cw-locked, the AMEE 104 performs a WriteBack (τ) process. Note that when a node τ which is included in the child nodes of the node ρ and for which the minor counter is not set to “end” is cached, the AMEE 104 determines that this node τ is in a dirty state. After that, the AMEE 104 disengages the sp-lock of the note t.

Further, when the node ρ is ex-locked, the AMEE 104 performs a WriteBack (ρ) process and disengages the lock. Further, when the node ρ is not ex-locked, the AMEE 104 stores the cache line ccl(ρ) of the node ρ in the authentication tree cache 102, and unlocks the node ρ.

### <ConAdd (ρ) Process>

Next, a ConAdd (ρ) process performed by the AMEE 104 will be described. The ConAdd (ρ) process is a process for adding a node ρ in the authentication tree during parallel processing.

It is assumed that the node ρ is a node that is not present (is not registered) in the authentication tree cache 102. Further, it is assumed that when the node ρ is an internal node, a storage area for the node ρ is allocated in the authentication tree cache 102, and the node ρ has been cw-locked for the node ρ. Firstly, a process performed in a lock phase of the ConAdd (ρ) process will be described. The process performed in the lock phase of the ConAdd (ρ) process is similar to that performed in the lock phase of the ConRead (ρ) process, and therefore its description will be omitted.

Next, a process performed in a memory phase of the ConAdd (ρ) process will be described. The process performed in the memory phase of the ConAdd (ρ) process is similar to that of the ConRead (ρ) process except that the Read (τ) process for a given node τ fails.

Next, a process performed in an unlock phase of the ConAdd (ρ) process will be described. Firstly, the AMEE 104 specifies, among the nodes for each of which the Read (φ) process has succeeded, an additional anchor φ which is an ancestor node closest to the node ρ. After that, the AMEE 104 unlocks all nodes τ that are present on a path from the parent node par(φ) of the additional anchor σ to the anchor anc(ρ) of the node ρ.

After that, the AMEE 104 arranges the nodes τ present on the path from the child node of the additional anchor σ to the node ρ in a descending order. After that, the AMEE 104 successively performs an Add (τ) process for each of all nodes τ arranged in the descending order. Note that when the parent node par(τ) of the node τ is not allocated a storage area by the authentication tree cache 102, the AMEE 104 performs a WriteBack (par (τ)) process and unlocks the node par(τ). On the other hand, when the node par(τ) is allocated a storage area by the authentication tree cache 102, the AMEE 104 moves the node par(τ) to the authentication tree cache 102 and unlocks the moved node par(τ).

After that, when the node ρ is an internal node, the AMEE 104 moves the cache line ccl(ρ) of this node ρ to the authentication tree cache 102 and unlocks the cache line ccl(ρ), whereas when the node ρ is a leaf node, the AMEE 104 returns the cache line ccl(ρ) of the node ρ to the data cache 101.

### <ConPrune (ρ) Process>

Next, a ConPrune (ρ) process performed by the AMEE 104 will be described. The ConPrune (ρ) process is a process for deleting a node ρ from the authentication tree during parallel processing.

It is assumed that the cache line ccl(ρ) of the node ρ is cached. Further, when the node ρ is an internal node, the node ρ is not cw-locked for the node ρ.

Firstly, a process performed in a lock phase of ConPrune (ρ) process will be described. The process performed in the lock phase of the ConPrune (ρ) process is basically similar to that performed in the lock phase of ConRead (ρ) process. However, when the node ρ is an internal node, the AMEE 104 first cw-locks the node ρ.

Next, a process performed in a memory phase of ConPrune (ρ) process will be described. The process performed in the memory phase of the ConPrune (ρ) process is similar to that performed in the memory phase of the ConRead (ρ) process, and therefore its description will be omitted.

Next, a process performed in an unlock phase of the ConPrune (ρ) process will be described. The AMEE 104 performs the below-described process for each of all nodes present on a path from the node ρ to a child node of the anchor anc(ρ) of the node ρ in order (i.e., in an ascending order). For example, when the node τ is a leaf node, the AMEE 104 performs a Prune (τ) process for this node τ. When the node τ is not a leaf node and all minor counters of the cache line ccl(τ) are set to “end”, the AMEE 104 performs a Prune (τ) process. When the node τ is not a leaf node and the node τ is not allocated a storage area by the cache, the AMEE 104 performs a WriteBack (τ) process and unlocks the node τ. When the node τ is not a leaf node and the node τ is allocated a storage area by the cache, the AMEE 104 unlocks the node τ.

Note that in the Prune (τ) process in the ConPrune (ρ) process, a ConCarryUp (par (τ)) process, instead of the CarryUp (par (τ)) process, is called. When the ConCarryUp (par (τ)) process is called, if the node par(τ) has been ex-locked, the AMEE 104 passes the cache line ccl(par (τ)) to the ConCarryUp (par (τ)) process as in the case of the ConWriteBack process. Further, in the Prune (τ) process in the ConPrune (ρ) process, a ConInvalidate (τ) process, instead of the Invalidate (τ) process, is called.

Next, a process for recursively calling a ConPrune (ρ) process will be described. When all minor counters of the cache line ccl(anc(ρ)) of the anchor anc(ρ) of the node ρ are set to “end”, the AMEE 104 recursively performs a ConPrune (anc(ρ)) process. Note that it is assumed that it is possible to independently delete corresponding data from the memory 103.

### <ConInvalidate (ρ) Process>

Next, a ConInvalidate (ρ) process will be described. It is assumed that the cache line ccl(ρ) of the node ρ is cached and indicates a clean state. The AMEE 104 waits until all locks for the node ρ are disengaged in the ConInvalidate (ρ) process, and then when all the locks are disengaged (or when they are not locked), performs an Invalidate process.

As described above, in the information processing device 1 according to the present disclosure, the AMEE 104 is configured, for the major counter and the minor counter assigned to each node, to be able to wait for a process for updating the value of the major counter which occurs as a result of a process for updating the value of the minor counter. As a result, the information processing device 1 can correctly perform parallel processing of authentication processes using the authentication tree. That is, the information processing device 1 can improve confidentiality while improving processing performance by parallel processing.

Note that in the present disclosure, some or all of the processes performed by the information processing device 1 may also carried out by causing a CPU to execute a computer program.

Specifically, the above-described program includes a set of instructions (or software codes) that, when being loaded into a computer, causes the computer to perform one or more of the functions described in the example embodiments. The program may be stored in a non-transitory computer readable medium or in a physical storage medium. By way of example rather than limitation, a computer readable medium or a physical storage medium may include a RAM (Random-Access Memory, a ROM (Read-Only Memory), an SSD (Solid-State Drive), or other memory technology. Further, by way of example rather than limitation, the computer readable medium or the physical storage medium may include a CD-ROM, a DVD (Digital Versatile Disc), a Blu-ray (Registered Trademark) disk, or other optical disk storages. Further, by way of example rather than limitation, the computer readable medium or the physical storage medium may include a magnetic cassette, a magnetic tape, and a magnetic disk storage, or other magnetic storage devices. The program may be transmitted on a transitory computer readable medium or a communication medium. By way of example rather than limitation, the transitory computer readable medium or the communication medium may include electrical, optical, acoustic, or other forms of propagating signals.

Although the present disclosure is described above with reference to example embodiments, the present disclosure is not limited to the above-described example embodiments. Various modifications that can be understood by those skilled in the art can be made to the configuration and details of the present disclosure within the scope and spirit of the disclosure. Further, the example embodiments may be combined with one another as appropriate.

Each of the drawings is merely an example to illustrate one or more embodiments. Each of the drawing is not associated with only one specific embodiment, but may be associated with one or more other embodiments. As will be understood by those skilled in the art, various features or steps described with reference to any one of the drawings may be combined with features or steps shown in one or more other drawings in order to create, for example, an embodiment that is not explicitly shown in the drawings or described in the specification. Not all of the features or steps shown in any one of the drawings to describe an embodiment are necessarily indispensable, and some features or steps may be omitted. The order of steps in any of the drawings may be changed as appropriate.

Further, the whole or part of the example embodiments disclosed above can be described as, but not limited to, the following supplementary notes.

(Supplementary note 1)

An information processing device comprising:
a memory;
an authentication tree cache in which some of counters, identifiers, and tags generated by using the counters and the identifiers, are temporarily stored, the counters and the identifiers being included in the authentication tree including a plurality of nodes connected with one another in a tree shape in which a pair of a counter and an identifier is assigned to each of the nodes;
a data cache in which some of a plurality of data respectively assigned to a plurality of leaf nodes are temporarily stored, the plurality of leaf nodes being nodes located in a lowest layer of the authentication tree among the plurality of nodes constituting the authentication tree; and
an authenticated memory encryption engine configured to perform a cryptographic process and an authentication process using the authentication tree for data to be exchanged between the data cache and the memory, and perform an authentication process for at least one tag respectively generated at at least one node present on a path from a leaf node to which the data is assigned to a root node, wherein
a counter assigned to each node in the authentication tree is formed of a major counter of which a value is represented by, among a plurality of bits representing a value of the counter, a high-order bit, and a minor counter of which a value is represented by a low-order bit,
the major counter is shared by a plurality of nodes having a common parent node, and
the authenticated memory encryption engine is configured, for the major counter and the minor counter assigned to each node, to be able to wait for a process for updating a value of the major counter which occurs as a result of a process for updating a value of the minor counter.
   (Supplementary note 2)

The information processing device described in Supplementary note 1, wherein when the authenticated memory encryption engine has updated a value of the major counter shared by the plurality of nodes having the common parent node, the authenticated memory encryption engine initializes a value of a minor counter of each of the plurality of nodes having the common parent node.

(Supplementary note 3)

The information processing device described in Supplementary note 1, wherein the authenticated memory encryption engine is further configured to be able to update a value of the major counter shared by the plurality of nodes having the common parent node without updating a value of a minor counter of each of the plurality of nodes having the common parent node.

(Supplementary note 4)

The information processing device described in Supplementary note 1,
wherein the authenticated memory encryption engine is further configured to:

lock, when updating a first node among the plurality of the nodes constituting the authentication tree by first access, all nodes present on a path from the first node to a node at which a cache line is stored in the authentication tree cache and which is closest to the first node among nodes present on a path from the first node to the root node, and then update the locked nodes; and
lock, when updating a second node among the plurality of the nodes constituting the authentication tree by second access following the first access, and when a third node, which is a node already locked due to the first access, is present on a path from the second node to the root node, all nodes present on a path from the second node to a node immediately before the third node, and after all the nodes locked due to the first access are unlocked, lock remaining nodes present on a path from the third node to a node at which a cache line is stored in the authentication tree cache and which is closest to the third node among nodes present on the path from the third node to the root node, and then update the locked nodes.
   (Supplementary note 5)

The information processing device described in Supplementary note 4, wherein the authenticated memory encryption engine is further configured to perform a process for updating a value of the major counter, which occurs as a result of a process for updating a value of the minor counter in a child node of the third node due to the first access, after the node locked due to the second access is updated.

(Supplementary note 6) The information processing device described in Supplementary note 4, wherein the authenticated memory encryption engine is further configured so as not to accept any additional process for a child node of the third node locked due to the second access before the process for updating the value of the major counter of the child node.
(Supplementary note 7)

The information processing device described in Supplementary note 1, wherein the authenticated memory encryption engine is further configured to:
update, when deleting any of the plurality of the nodes constituting the authentication tree, a value of the major counter assigned to a parent node of the node to be deleted based on a value of the major counter assigned to the parent node of the node to be deleted; and
set, when adding a new node at a position where the deleted node was originally located in the authentication tree, a value of the major counter assigned to the added node based on the major counter assigned to a parent node of the added node.
   (Supplementary note 8)

The information processing device described in Supplementary note 7, wherein the authenticated memory encryption engine is further configured to:
update, when deleting any of the plurality of the nodes constituting the authentication tree, a value of a major counter assigned to the parent node of the node to be deleted to a value larger than a larger one of the value of the major counter assigned to the parent node of the node to be deleted and a value of a major counter assigned to the node to be deleted; and
set, when adding a new node at the position where the deleted node was originally located in the authentication tree, a value of the major counter assigned to the added node to a value equal to or larger than the value of the major counter assigned to the parent node of the added node.
   (Supplementary note 9)

A method for controlling an information processing device, the information processing device comprising:
a memory;
an authentication tree cache in which some of counters, identifiers, and tags generated by using the counters and the identifiers, are temporarily stored, the counters and the identifiers being included in the authentication tree including a plurality of nodes connected with one another in a tree shape in which a pair of a counter and an identifier is assigned to each of the nodes;
a data cache in which some of a plurality of data respectively assigned to a plurality of leaf nodes are temporarily stored, the plurality of leaf nodes being nodes located in a lowest layer of the authentication tree among the plurality of nodes constituting the authentication tree; and
an authenticated memory encryption engine configured to perform a cryptographic process and an authentication process using the authentication tree for data to be exchanged between the data cache and the memory, and perform an authentication process for at least one tag respectively generated at at least one node present on a path from a leaf node to which the data is assigned to a root node, wherein
a counter assigned to each node in the authentication tree is formed of a major counter of which a value is represented by, among a plurality of bits representing a value of the counter, a high-order bit, and a minor counter of which a value is represented by a low-order bit, and
the major counter is shared by a plurality of nodes having a common parent node,
the method comprising:
delaying, for the major counter and the minor counter assigned to each node, a process for updating a value of the major counter which occurs as a result of a process for updating a value of the minor counter,
performing a process for updating a value of another minor counter assigned to another node of which a parent node is the same as that of the node to which the minor counter is assigned, and
performing a process for updating the value of the major counter.
   (Supplementary note 10)

A control program for causing a computer to perform a process for controlling an information processing device, the information processing device comprising:
a memory;
an authentication tree cache in which some of counters, identifiers, and tags generated by using the counters and the identifiers, are temporarily stored, the counters and the identifiers being included in the authentication tree including a plurality of nodes connected with one another in a tree shape in which a pair of a counter and an identifier is assigned to each of the nodes;
a data cache in which some of a plurality of data respectively assigned to a plurality of leaf nodes are temporarily stored, the plurality of leaf nodes being nodes located in a lowest layer of the authentication tree among the plurality of nodes constituting the authentication tree; and
an authenticated memory encryption engine configured to perform a cryptographic process and an authentication process using the authentication tree for data to be exchanged between the data cache and the memory, and perform an authentication process for at least one tag respectively generated at at least one node present on a path from a leaf node to which the data is assigned to a root node, wherein
a counter assigned to each node in the authentication tree is formed of a major counter of which a value is represented by, among a plurality of bits representing a value of the counter, a high-order bit, and a minor counter of which a value is represented by a low-order bit, and
the major counter is shared by a plurality of nodes having a common parent node,
the program being configured to further cause the computer to perform:
a process for delaying, for the major counter and the minor counter assigned to each node, a process for updating a value of the major counter which occurs as a result of a process for updating a value of the minor counter,
a process for performing a process for updating a value of another minor counter assigned to another node of which a parent node is the same as that of the node to which the minor counter is assigned, and
a process for performing a process for updating the value of the major counter.

Some or all of the elements (e.g., structures and functions) described in Supplementary notes 2 to 8 that are dependent on Supplementary note 1 can be dependent on Supplementary notes 9 and 10 by the same dependency relationships as those in Supplementary notes 2 to 8.

Some or all of the elements described in any of the supplementary notes can be applied to various types of hardware, software, recording means for recording software, systems, and methods.

The present disclosure provides an information processing device, a method for controlling an information processing device, and a control program capable of improving confidentiality while improving processing performance by parallel processing.

The first and second example embodiments can be combined as desirable by one of ordinary skill in the art.

While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims.

What is claimed is:

1. An information processing device comprising:
a memory;
an authentication tree cache in which some of counters, identifiers, and tags generated by using the counters and the identifiers, are temporarily stored, the counters and the identifiers being included in the authentication tree including a plurality of nodes connected with one another in a tree shape in which a pair of a counter and an identifier is assigned to each of the nodes;
a data cache in which some of a plurality of data respectively assigned to a plurality of leaf nodes are temporarily stored, the plurality of leaf nodes being nodes located in a lowest layer of the authentication tree among the plurality of nodes constituting the authentication tree; and
an authenticated memory encryption engine configured to perform a cryptographic process and an authentication process using the authentication tree for data to be exchanged between the data cache and the memory, and perform an authentication process for at least one tag respectively generated at at least one node present on a path from a leaf node to which the data is assigned to a root node, wherein
a counter assigned to each node in the authentication tree is formed of a major counter of which a value is represented by, among a plurality of bits representing a value of the counter, a high-order bit, and a minor counter of which a value is represented by a low-order bit,
the major counter is shared by a plurality of nodes having a common parent node, and
the authenticated memory encryption engine is configured, for the major counter and the minor counter assigned to each node, to be able to wait for a process for updating a value of the major counter which occurs as a result of a process for updating a value of the minor counter.

2. The information processing device according to claim 1, wherein when the authenticated memory encryption engine has updated a value of the major counter shared by the plurality of nodes having the common parent node, the authenticated memory encryption engine initializes a value of a minor counter of each of the plurality of nodes having the common parent node.

3. The information processing device according to claim 1, wherein the authenticated memory encryption engine is further configured to be able to update a value of the major counter shared by the plurality of nodes having the common parent node without updating a value of a minor counter of each of the plurality of nodes having the common parent node.

4. The information processing device according to claim 1, wherein the authenticated memory encryption engine is further configured to:
lock, when updating a first node among the plurality of the nodes constituting the authentication tree by first access, all nodes present on a path from the first node to a node at which a cache line is stored in the authentication tree cache and which is closest to the first node among nodes present on a path from the first node to the root node, and then update the locked nodes; and
lock, when updating a second node among the plurality of the nodes constituting the authentication tree by second access following the first access, and when a third node, which is a node already locked due to the first access, is present on a path from the second node to the root node, all nodes present on a path from the second node to a node immediately before the third node, and after all the nodes locked due to the first access are unlocked, lock remaining nodes present on a path from the third node to a node at which a cache line is stored in the authentication tree cache and which is closest to the first node among nodes present on the path from the third node to the root node, and then update the locked nodes.

5. The information processing device according to claim 4, wherein the authenticated memory encryption engine is further configured to perform a process for updating a value of the major counter, which occurs as a result of a process for updating a value of the minor counter in a child node of the third node due to the first access, after the node locked due to the second access is updated.

6. The information processing device according to claim 4, wherein the authenticated memory encryption engine is further configured so as not to accept any additional process for a child node of the third node locked due to the second access before the process for updating the value of the major counter of the child node.

7. The information processing device according to claim 1, wherein the authenticated memory encryption engine is further configured to:
update, when deleting any of the plurality of the nodes constituting the authentication tree, a value of the major counter assigned to a parent node of the node to be deleted based on a value of the major counter assigned to the parent node of the node to be deleted; and
set, when adding a new node at a position where the deleted node was originally located in the authentication tree, a value of the major counter assigned to the added node based on the major counter assigned to a parent node of the added node.

8. The information processing device according to claim 7, wherein the authenticated memory encryption engine is further configured to:
update, when deleting any of the plurality of the nodes constituting the authentication tree, a value of a major counter assigned to the parent node of the node to be deleted to a value larger than a larger one of the value of the major counter assigned to the parent node of the node to be deleted and a value of a major counter assigned to the node to be deleted; and
set, when adding a new node at the position where the deleted node was originally located in the authentication tree, a value of the major counter assigned to the added node to a value equal to or larger than the value of the major counter assigned to the parent node of the added node.

9. A method for controlling an information processing device,
the information processing device comprising:
a memory;
an authentication tree cache in which some of counters, identifiers, and tags generated by using the counters and the identifiers, are temporarily stored, the counters and the identifiers being included in the authentication tree including a plurality of nodes connected with one another in a tree shape in which a pair of a counter and an identifier is assigned to each of the nodes;
a data cache in which some of a plurality of data respectively assigned to a plurality of leaf nodes are temporarily stored, the plurality of leaf nodes being nodes located in a lowest layer of the authentication tree among the plurality of nodes constituting the authentication tree; and
an authenticated memory encryption engine configured to perform a cryptographic process and an authentication process using the authentication tree for data to be exchanged between the data cache and the memory, and perform an authentication process for at least one tag respectively generated at at least one node present on a path from a leaf node to which the data is assigned to a root node, wherein
a counter assigned to each node in the authentication tree is formed of a major counter of which a value is represented by, among a plurality of bits representing a value of the counter, a high-order bit, and a minor counter of which a value is represented by a low-order bit, and
the major counter is shared by a plurality of nodes having a common parent node,
the method comprising:
delaying, for the major counter and the minor counter assigned to each node, a process for updating a value of the major counter which occurs as a result of a process for updating a value of the minor counter,
performing a process for updating a value of another minor counter assigned to another node of which a parent node is the same as that of the node to which the minor counter is assigned, and
performing a process for updating the value of the major counter.

10. A non-transitory computer readable medium storing a control program for causing a computer to perform a process for controlling an information processing device,
the information processing device comprising:
a memory;
an authentication tree cache in which some of counters, identifiers, and tags generated by using the counters and the identifiers, are temporarily stored, the counters and the identifiers being included in the authentication tree including a plurality of nodes connected with one another in a tree shape in which a pair of a counter and an identifier is assigned to each of the nodes;
a data cache in which some of a plurality of data respectively assigned to a plurality of leaf nodes are temporarily stored, the plurality of leaf nodes being nodes located in a lowest layer of the authentication tree among the plurality of nodes constituting the authentication tree; and
an authenticated memory encryption engine configured to perform a cryptographic process and an authentication process using the authentication tree for data to be exchanged between the data cache and the memory, and perform an authentication process for at least one tag respectively generated at at least one node present on a path from a leaf node to which the data is assigned to a root node, wherein
a counter assigned to each node in the authentication tree is formed of a major counter of which a value is represented by, among a plurality of bits representing a value of the counter, a high-order bit, and a minor counter of which a value is represented by a low-order bit, and
the major counter is shared by a plurality of nodes having a common parent node,
the program being configured to further cause the computer to perform:
a process for delaying, for the major counter and the minor counter assigned to each node, a process for updating a value of the major counter which occurs as a result of a process for updating a value of the minor counter,
a process for performing a process for updating a value of another minor counter assigned to another node of which a parent node is the same as that of the node to which the minor counter is assigned, and
a process for performing a process for updating the value of the major counter.
